(19) United States
(12) Patent Application Publication
(10) Pub. No.: US 2010/0122272 A1
(43) Pub. Date: May 13, 2010

(54) SLOT-IN TYPE DISK APPARATUS

(75) Inventor: Mikio Fujii, Ehime (JP)

Correspondence Address: Dickinson Wright PLLC;James E. Ledbetter, Esq., International Square, 1875 Eye Street, N.W., Suite 1200, Washington, DC, 20006, US

(73) Assignee: Matsusshita Electric Industrial Co., Ltd., Osaka (JP)

(21) Appl. No.: 12/161,297

(22) PCT Filed: Jan. 19, 2007
(86) PCT No.: PCT/JP2007/050826

§ 371 Date: Feb. 5, 2009

(30) Foreign Application Priority Data
Jan. 23, 2006 (JP) 2005-014348

(51) Int. Cl. G11B 17/04

(52) U.S. Cl. 720/620; G9B/17.013

(57) ABSTRACT

It is an object of the present invention to provide a slot-in type disk apparatus which can further be thinned without deteriorating strengths of a lever and a base body. The slot-in type disk apparatus in which a base body 10 and a lid constitute a chassis sheath, a disk-insertion opening 11 into which a disk is directly inserted is formed in a front surface of the chassis sheath, wherein an opening 2 is formed in a portion of the base body 10, a plate which is thinner than the base body 10 is mounted to the opening 2, thereby forming a space which is recessed more than a surface of the base body 10 on the side of the lid, and a position above the space is a movement range of a lever which pulls in the disk.

### TECHNICAL FIELD

The present invention relates to a disk apparatus for recording or replaying into or from a disk-like recording medium such as a CD and a DVD, and more particularly, to a slot-in type disk apparatus into which and from which a disk can directly be inserted or discharged.

### BACKGROUND TECHNIQUE

According to a conventional disk apparatus, there is widely employed a loading system in which a disk is placed on a tray or a turntable, and the tray or the turntable is loaded into an apparatus body. According to such a loading system, since the tray or the turntable is required, there is a limit to reduce the thickness of the disk apparatus body. Therefore, there recently exists a slot-in type disk apparatus in which a disk is directly operated by a lever or the like using a loading motor (e.g., patent document 1).

### [Patent Document 1] Japanese Patent Application Laid-open No. 2002-352498

### DISCLOSURE OF THE INVENTION

### Problem to be Solved by the Invention

Even if the disk apparatus is of the slot-in type in which a disk is directly operated by a lever or the like, in order to further reduce the apparatus in thickness, it is necessary to reduce the plate thickness of the lever or a base body, but if the plate thickness is reduced, sufficient strength can not be obtained.

Hence, it is an object of the present invention to provide a slot-in type disk apparatus which can be reduced in thickness without deteriorating strength of a lever or a base body.

### Means for Solving the Problem

A first aspect of the present invention provides a slot-in type disk apparatus in which a base body and a lid constitute a chassis sheath, and a disk-insertion opening into which a disk is directly inserted is formed in a front surface of the chassis sheath, wherein an opening is formed in a portion of the base body, a plate which is thinner than the base body is mounted to the opening, thereby forming a space which is recessed more than a surface of the base body on the side of the lid, and a position above the space is a movement range of a lever which pulls in the disk.

According to a second aspect of the invention, in the slot-in type disk apparatus of the first aspect, the base body is constituted by a deep bottom and a shallow bottom, a wing portion extending from a front surface to a rear surface is formed by the shallow bottom, and the wing portion is provided with the space.

A third aspect of the invention provides a slot-in type disk apparatus in which a base body and a lid constitute a chassis sheath, the base body is constituted by a deep bottom and a shallow bottom, a wing portion extending from a front surface to a rear surface is formed by the shallow bottom, and a disk-insertion opening into which a disk is directly inserted is formed in a front surface of the chassis sheath, wherein an opening is formed in a portion of the wing portion, a plate which is thinner than the wing portion is mounted to the opening, thereby forming a space which is recessed more than a surface of the wing portion on the side of the lid, the wing portion is provided with a pull-in lever, the pull-in lever is moved by a sub-lever, and a position above the space is a movement range of the sub-lever.

According to a fourth aspect of the invention, in the slot-in type disk apparatus of the third aspect, the sub-lever is provided at its one end with a convex portion and at its other end with a turning fulcrum, the turning fulcrum is disposed on the deep bottom, the convex portion slides in a long groove of the pull-in lever, the convex portion is disposed on a surface of the sub-lever on the side of the lid, and the long groove is disposed in a surface of the pull-in lever on the side of the base body.

According to a fifth aspect of the invention, in the slot-in type disk apparatus of the fourth aspect, the space is formed into a sector shape having an arc side corresponding to a moving locus of the convex portion.

### EFFECT OF THE INVENTION

According to the present invention, a plate thickness of the lever can sufficiently be secured, and a cap in which the lever moves is secured by the space formed by mounting the plate is secured. With this, the thickness of the apparatus can be reduced.

### BRIEF DESCRIPTION OF THE DRAWINGS

FIG. 1 is a schematic plan view of a base body of a disk apparatus according to an embodiment of the present invention; and

FIG. 2 is a perspective view of an essential portion of the base body of the disk apparatus.

### EXPLANATION OF SYMBOLS

1 plate
2 opening
10 base body
11 disk-insertion opening

### BEST MODE FOR CARRYING OUT THE INVENTION

According to the slot-in type disk apparatus of the first aspect of the invention, an opening is formed in a portion of the base body, a plate which is thinner than the base body is mounted to the opening, thereby forming a space which is recessed more than a surface of the base body on the side of the lid, and a position above the space is a movement range of a lever which pulls in the disk. With this aspect, the thickness of the lever is sufficiently secured, a gap in which the lever moves is secured by the space formed by mounting the plate, and the thickness of the apparatus can be reduced.

According to the second embodiment, in the slot-in type disk apparatus of the first aspect, the base body is constituted by a deep bottom and a shallow bottom, a wing portion extending from a front surface to a rear surface is formed by the shallow bottom, and the wing portion is provided with the space. With this aspect, the wing portion can be reduced in thickness.

According to the slot-in type disk apparatus of the third aspect of the invention, an opening is formed in a portion of the wing portion, a plate which is thinner than the wing portion is mounted to the opening, thereby forming a space which is recessed more than a surface of the wing portion on the side of the lid, the wing portion is provided with a pull-in lever, the pull-in lever is moved by a sub-lever, and a position above the space is a movement range of the sub-lever. With this aspect, the thickness of the lever can sufficiently be secured, a gap between the sub-lever and a disk when it is replayed is secured, thereby preventing the disk from coming into contact with the sub-lever, and the apparatus can be reduced in thickness. Further, if the sub-lever is disposed closer to the base body than the pull-in lever as in this embodiment, the pull-in lever can be separated away from the base body. Therefore, a distance between the base body and the pull-in lever which supports the disk can be secured, and it is possible to prevent a disk from coming into contact with the apparatus when the disk is inserted.

According to the fourth embodiment, in the slot-in type disk apparatus of the third aspect, the sub-lever is provided at its one end with a convex portion and at its other end with a turning fulcrum, the turning fulcrum is disposed on the deep bottom, the convex portion slides in a long groove of the pull-in lever, the convex portion is disposed on a surface of the sub-lever on the side of the lid, and the long groove is disposed in a surface of the pull-in lever on the side of the base body. With this aspect, since the sub-lever is disposed closer to the base body than the pull-in lever, the sub-lever can move smoothly due to this space.

According to the fifth embodiment, in the slot-in type disk apparatus of the fourth aspect, the space is formed into a sector shape having an arc side corresponding to a moving locus of the convex portion. With this aspect, the space can be formed such that the strength of the wing portion is not deteriorated.

### Embodiment

A disk apparatus according to an embodiment of the present invention will be explained.

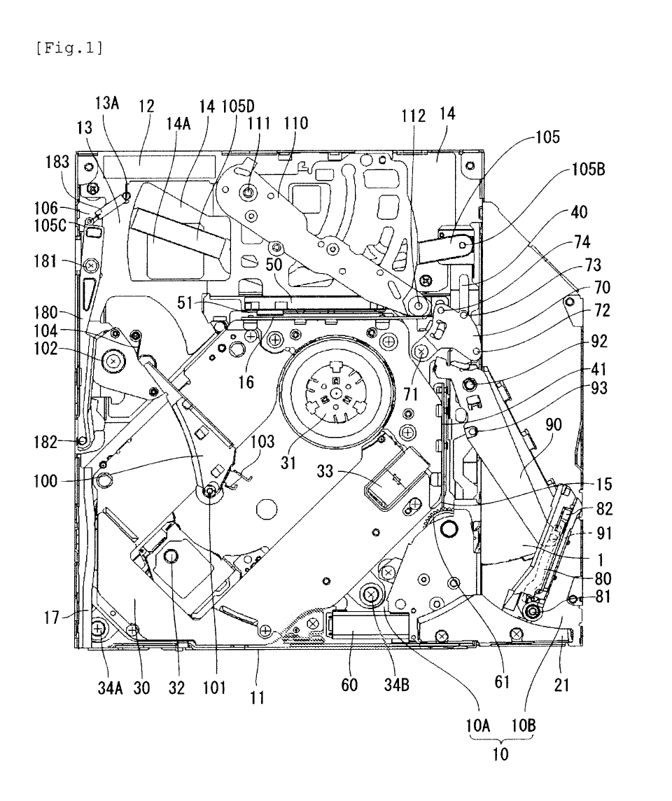

FIG. 1 is a plan view of a base body of the disk apparatus.

According to the disk apparatus of the embodiment, abase body and lid constitute a chassis sheath, and a bezel is attached to a front surface of the chassis sheath. The disk apparatus of the embodiment is a slot-in type disk apparatus in which a disk is directly inserted from a disk-insertion opening formed in the bezel.

As shown in FIG. 1, parts which realize the recording and replaying function onto or from a disk and a loading function of a disk are attached to the base body 10.

The base body 10 is formed with a deep bottom 10A and a shallow bottom 10B. A wing portion extending from a front surface to a rear surface is formed by the shallow bottom 10B. The wing portion is provided at its portion with a plate 1.

The base body 10 is formed at its front side with a disk-insertion opening 11 into which a disk is directly inserted, and a connector 12 is disposed on an end of a rear surface of the base body 10. A traverse base 30 is disposed on the base body 10 on the side of the disk-insertion opening 11, and a rear base 13 is disposed on the base body 10 on the side of the connector 12. The traverse base 30 and the rear base 13 are disposed such that they are not superposed on each other. A printed board 14 is provided on the rear base 13 on the side of the surface of the base body 10.

The traverse base 30 holds a spindle motor 31, a pickup 32 and driving means 33 which moves the pickup 32. The spindle motor 31 is provided on the one end side of the traverse base 30, and the pickup 32 is provided such that the pickup 32 can move from one end to the other end of the traverse base 30. When the pickup 32 is stopped, it is disposed on the side of the other end of the traverse base 30, i.e., on the outer peripheral side of the base body 10.

In the traverse base 30, the spindle motor 31 is located at a central portion of the base body 10, a reciprocating range of the pickup 32 is located closer to the disk-insertion opening 11 than the spindle motor 31, and the reciprocating direction of the pickup 32 is different from the insertion direction of the disk. Here, an angle of 45° is formed between the reciprocating direction of the pickup 32 and the insertion direction of a disk.

The traverse base 30 is supported on the base body 10 by a pair of insulators 34A and 34B.

The pair of insulators 34A and 34B are disposed closer to a stationary position of the pickup 32 than the position of the spindle motor 31. In this embodiment, the insulator 34A is provided on the side of one end near the inner side of the disk-insertion opening 11, and the insulator 34B is provided at a central portion near the inner side of the disk-insertion opening 11. The insulators 34A and 34B includes damper mechanisms made of elastic material. The traverse base 30 brings the spindle motor 31 toward the base body 10 and away from the base body 10 around the insulators 34A and 34B as fulcrums.

A main slider 40 and a sub-slider 50 and a sub-slider 50 having cam mechanisms will be explained below. The cam mechanisms which displace the traverse base 30 are respectively provided on the main slider 40 and the sub-slider 50. The main slider 40 and the sub-slider 50 are disposed on the side of the spindle motor 31. The main slider 40 is disposed such that its one end comes on the side of a front surface of the chassis body 10 and its other end comes on the side of a rear surface of the chassis body 10. The sub-slider 50 is disposed between the traverse base 30 and the rear base 13 in a direction perpendicular to the main slider 40.

The cam mechanisms which displace the traverse base 30 comprise a first cam mechanism 41 and a second cam mechanism 51. The first cam mechanism 41 is provided on a surface of the main slider 40 on the side of the spindle motor 31, and the second cam mechanism 51 is provided on the sub-slider 50 on the side of the spindle motor 31.

A base member 15 is provided between the main slider 40 and the traverse base 30. Abase member 16 is provided between the sub-slider 50 and the traverse base 30. The base member 15 and the base member 16 are fixed to the base body 10. A position of a cam pin of the traverse base 30 is limited by a vertical groove formed in the base member 15, and a position of the cam pin of the traverse base 30 is limited by a vertical groove formed in the base member 16.

The base member 16 and the sub-slider 50 are connected to each other through a third cam mechanism (not shown). The third cam mechanism has a function for moving the sub-slider 50 away from the base body 10 when the traverse base 30 is moved away from the base body 10 by the second cam mechanism 51.

A loading motor 60 is disposed on the side of one end of the main slider 40. A drive shaft of the loading motor 60 and the one end of the main slider 40 are connected to each other through a gear mechanism 61.

By driving the loading motor 60, the main slider 40 can slide in the longitudinal direction. The main slider 40 is connected to the sub-slider 50 by a cam lever 70.

The cam lever 70 includes a turning fulcrum 71, a pin 72, a pin 73 and a pin 74. The pins 72 and 73 engage with a cam groove formed in an upper surface of the main slider 40, the pin 74 engages a cam groove formed in an upper surface of the sub-slider 50, and the cam lever 70 turns around a turning fulcrum 71 as an axis.

The above-explained connector 12, traverse base 30, rear base 13, printed board 14, insulators 34A and 34B, main slider 40, sub-slider 50 and loading motor 60 are provided on the deep bottom 10A of the base body 10, and form a disk inserting space between these members and the lid.

Next, a guide member for supporting a disk when the disk is to be inserted, and a lever member which operates when a disk is inserted will be explained below.

A first disk guide 17 having a predetermined length is provided on the side of one end of the deep bottom 10A near the disk-insertion opening 11. The first disk guide 17 has a groove having a U-shaped cross section as viewed from the disk inserting side. A disk is supported by this groove.

A pull-in lever 80 is provided on the shallow bottom 10B on the side of the disk-insertion opening 11. A second disk guide 81 is provided on a movable side end of the pull-in lever 80. The second disk guide 81 comprises a cylindrical roller, and is turnably provided on the movable end of the pull-in lever 80. A groove is formed in a roller outer periphery of the second disk guide 81, and a disk is supported by this groove.

The movable end of the pull-in lever 80 is operated closer to the disk-insertion opening 11 than the stationary side. The pull-in lever 80 has a turning fulcrum 82 on the stationary end.

The pull-in lever 80 is operated by a sub-lever 90.

The sub-lever 90 has a projection 91 on the movable side one end, and a turning fulcrum 92 on the other end. The projection 91 of the sub-lever 90 slides in a long groove in the pull-in lever 80. The turning fulcrum 92 of the sub-lever 90 is located on the main slider 40. The turning fulcrum 92 is not operated in association with the main slider 40, and is fixed to the rear base 13. A pin 93 is provided on a lower surface of the sub-lever 90 at a location closer to the projection 91 than the turning fulcrum 92. The pin 93 slides in the cam groove formed in an upper surface of the main slider 40. Therefore, the angle of the sub-lever 90 is changed as the main slider 40 moves, and if the angle of the sub-lever 90 is changed, the turning angle of the pull-in lever 80 is changed. That is, the second disk guide 81 of the pull-in lever 80 moves toward and away from the spindle motor 31 by the operation of the sub-lever 90.

A discharge lever 100 is provided on a side of the base body 10 which is different from the pull-in lever 80. A guide 101 is provided on a movable side end on the side of one end of the discharge lever 100. A turning fulcrum 102 is provided on the other end of the discharge lever 100. An abutment portion 103 is provided on the movable side end of the discharge lever 100 on the side of a rear surface as compared with the guide 101. The discharge lever 100 is provided with an elastic body 104. One end of the elastic body 104 is fixed to the discharge lever 100, and the other end is fixed to the rear base 13. When the abutment portion 103 is pulled toward the rear surface, the abutment portion 103 abuts against an abutment portion 13A of the rear base 13. The discharge lever 100 is pulled out toward the disk-insertion opening 11 by elastic force of the elastic body 104. The discharge lever 100 is operated in association with the main slider 40 through a link arm 105.

A guide lever 180 is provided on a side of the base body 10 that is on the same side where the discharge lever 100 exists. A rear surface of the guide lever 180 is a turning fulcrum 181, and a movable side of the guide lever 180 has a guide 182. The guide lever 180 is biased by an elastic body such that the side of the guide 182 projects toward a disk. The guide lever 180 is operated in associated with the main slider 40 through the link arm 105, and the side of the guide 182 is separated from a disk in accordance with motion of the main slider 40.

A restriction lever 110 is provided on the side of a rear surface of the base body 10. An end of the restriction lever 110 on the side of its rear surface is a turning fulcrum 111, and an end of the restriction lever 110 on the movable side has a guide 112. The side of the guide 112 of the restriction lever 110 is always biased such as to project toward the front side by an elastic body. The restriction lever 110 operates a limit switch at a predetermined position. That is, if a disk is inserted to a predetermined position, the limit switch is turned OFF, and the loading motor 60 is driven. If the loading motor 60 is driven, the main slider 40 slides.

The base body 10 is provided at its front side with a front guider 21. The front guider 21 is provided on the side of one end of the disk-insertion opening 11, and is disposed between the pull-in lever 80 and the disk-insertion opening 11. The front guider 21 is provided closer to the lid 20 than the loading motor 60, the gear mechanism and the main slider 40 such as to cover portions of the loading motor 60, the gear mechanism and the main slider 40.

The operation of the cam lever will be explained below.

While the pin 73 is in engagement with the cam groove of the main slider 40, the cam lever 70 does not turn. This state is the standby state. This state continues for a while even after a disk is loaded, and the traverse base 30 is close to the base body 10.

The pin 73 comes out from the cam groove of the main slider 40 when the center of the disk comes above the spindle motor 31, and the cam lever 70 starts turning.

The main slider 40 has a groove in which the pin 72 of the cam lever 70 slides, and the first cam mechanism 41 is moved in the same direction as the main slider 40 by motion of the cam lever 70. If the cam lever 70 turns, the sub-slider 50 is moved, and if the sub-slider 50 is moved, the second cam mechanism 51 is operated.

That is, if the cam lever 70 turns, the first cam mechanism 41 and the second cam mechanism 51 are moved by predetermined distances, and the traverse base 30 is displaced.

When the chucking motion is completed, the turning motion of the cam lever 70 is completed.

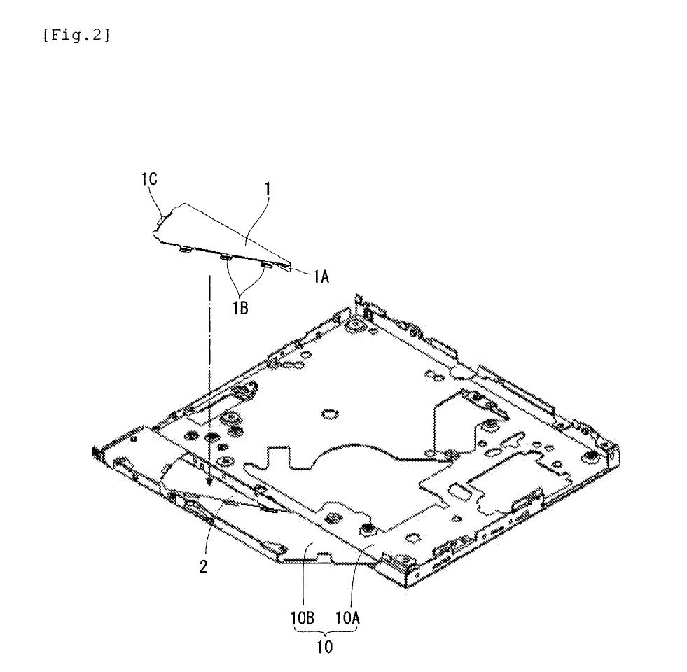

Next, a structure of the wing portion will be explained using FIG. 2. FIG. 2 is a perspective view of an essential portion of the base body of the embodiment.

As shown in FIG. 2, the shallow bottom 10B forming the wing portion is formed with a sector opening 2. A plate 1 having a sector flat portion is mounted to the opening 2. The plate 1 is made of material which is thinner than the shallow bottom 10B. A mounting piece 1A is formed on one side of the flat portion, projections 1B are formed on the other side of the flat portion, and a projection 1C is formed on an arc portion of the flat portion. The mounting piece 1A is hook-fixed to a sidewall of the deep bottom 10A. The projections 1B and 1C are retained to a periphery of the opening 2. By mounting the plate 1 to the opening 2 by the mounting piece 1A and the projections 1B and 1C, a space which is recessed than a lid-side surface of the shallow bottom 10B is formed at a position above the plate 1. The sub-lever 90 moves at a position above the space. The plate 1 is mounted such that its lower surface is flush with back and front surfaces of the shallow bottom 10B.

According to the embodiment, the recessed space is formed, and the sub-lever 90 is operated at a position above this space. With this, a thickness of the sub-lever 90 is sufficiently secured, a gap between the sub-lever 90 and a disk when it is replayed is secured, it is possible to prevent the disk from coming into contact with the sub-lever 90, and the apparatus can be reduced in thickness. If the sub-lever 90 is disposed closer to the base body 10 than the pull-in lever 80 as in this embodiment, the pull-in lever 80 can be separated from the base body 10. Therefore, a distance between the base body 10 and the pull-in lever 80 which supports a disk can be secured and thus, it is possible to prevent the disk from coming into contact with the base body 10 when the disk is inserted.

This application is based upon and claims the benefit of priority of Japanese Patent Application NO. 2006-14348 filed on Jan. 23, 2006, the contents of which are incorporated herein by reference in its entirety.

### INDUSTRIAL APPLICABILITY

In a disk apparatus for recording or replaying into or from a disk-like recording medium such as a CD and a DVD, the present invention can be utilized for a disk apparatus which is used as a domestic video device or a peripheral device of a computer, and which needs to be reduced in thickness.

1. A slot-in type disk apparatus in which
a base body and a lid constitute a chassis sheath, and
a disk-insertion opening into which a disk is directly inserted is formed in a front surface of the chassis sheath, wherein
an opening is formed in a portion of the base body,
a plate which is thinner than the base body is mounted to the opening, thereby forming a space which is recessed more than a surface of the base body on the side of the lid, and
a position above the space is a movement range of a lever which pulls in the disk.

2. The slot-in type disk apparatus according to claim 1, wherein
the base body is constituted by a deep bottom and a shallow bottom,
a wing portion extending from a front surface to a rear surface is formed by the shallow bottom, and
the wing portion is provided with the space.

3. A slot-in type disk apparatus in which
a base body and a lid constitute a chassis sheath,
the base body is constituted by a deep bottom and a shallow bottom,
a wing portion extending from a front surface to a rear surface is formed by the shallow bottom, and
a disk-insertion opening into which a disk is directly inserted is formed in a front surface of the chassis sheath, wherein
an opening is formed in a portion of the wing portion,
a plate which is thinner than the wing portion is mounted to the opening, thereby forming a space which is recessed more than a surface of the wing portion on the side of the lid,
the wing portion is provided with a pull-in lever,
the pull-in lever is moved by a sub-lever, and
a position above the space is a movement range of the sub-lever.

4. The slot-in type disk apparatus according to claim 3, wherein
the sub-lever is provided at its one end with a convex portion and at its other end with a turning fulcrum,
the turning fulcrum is disposed on the deep bottom,
the convex portion slides in a long groove of the pull-in lever,
the convex portion is disposed on a surface of the sub-lever on the side of the lid, and the long groove is disposed in a surface of the pull-in lever on the side of the base body.

5. The slot-in type disk apparatus according to claim 4, wherein
the space is formed into a sector shape having an arc side corresponding to a moving locus of the convex portion.
